(19) United States
(12) Patent Application Publication
(10) Pub. No.: US 2025/0157769 A1
(43) Pub. Date: May 15, 2025

(54) RELAY CIRCUIT AND VEHICLE INCLUDING THE SAME

(71) Applicant: TOYOTA JIDOSHA KABUSHIKI KAISHA, Toyota-shi (JP)

(72) Inventor: Yusuke SHIMOGAKI, Nagoya-shi (JP)

(73) Assignee: TOYOTA JIDOSHA KABUSHIKI KAISHA, Toyota-shi (JP)

(21) Appl. No.: 18/769,645

(22) Filed: Jul. 11, 2024

(30) Foreign Application Priority Data
Nov. 13, 2023 (JP) 2023-192985

(51) Int. Cl. H01H 50/44; B60L 3/04; H01H 47/00; H01H 50/14

(52) U.S. Cl. CPC H01H 50/443; B60L 3/04; H01H 47/002; H01H 50/14

(57) ABSTRACT

A relay circuit includes a contact relay and a voltage generating circuit. The contact relay includes an electrical contact and a coil. The coil drives the electrical contacts. The voltage generating circuit generates an application voltage to the coil. The electrical contact is closed when the application voltage exceeds the operating voltage of the contact relay and is opened when the application voltage falls below the return voltage of the contact relay that is lower than the operating voltage. The voltage generating circuit closes the electrical contact by generating an application voltage such that the application voltage exceeds the operating voltage, and then generates an application voltage such that the application voltage is held at a step-down voltage lower than the operating voltage and higher than the return voltage.

### CROSS-REFERENCE TO RELATED APPLICATION

This application claims priority to Japanese Patent Application No. 2023-192985 filed on Nov. 13, 2023, incorporated herein by reference in its entirety.

### BACKGROUND

### 1. Technical Field

The present disclosure relates to a relay circuit and a vehicle including the relay circuit.

### 2. Description of Related Art

Japanese Unexamined Patent Application Publication No. 2007-244034 (JP 2007-244034 A) discloses a power supply device for a vehicle. The power supply device includes a battery and a contact relay. The electrical contact of the contact relay is driven using electric power of the battery.

### SUMMARY

The electrical contact is generally driven by a coil. For example, the electrical contact is opened or closed based on a voltage applied to the coil. JP 2007-244034 A does not discuss a technology for effectively reducing power consumption at the time of driving the electrical contact.

The present disclosure has been made to solve the above issue, and an object of the present disclosure is to provide a relay circuit and a vehicle in which power consumption at the time of driving an electrical contact can be reduced effectively.

The relay circuit of the present disclosure includes a contact relay and a voltage generating circuit.

The contact relay includes an electrical contact and a coil configured to drive the electrical contact.
The voltage generating circuit is connected to the coil and configured to generate an application voltage for the coil.
The electrical contact is closed when the application voltage exceeds a first voltage.
The electrical contact is opened when the application voltage is below a second voltage lower than the first voltage. The voltage generating circuit is configured to generate the application voltage exceeding the first voltage to close the electrical contact, and then generate the application voltage reduced to and kept at a third voltage lower than the first voltage and higher than the second voltage.

According to the present disclosure, it is possible to effectively reduce the power consumption at the time of driving the electrical contact.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a vehicle in which a relay circuit is mounted;

FIG. 2 is a diagram illustrating a detailed configuration of a relay circuit;

FIG. 3 is a timing diagram for specifically explaining the transition of the application voltage to the coil;

FIG. 4 is a flowchart illustrating a process executed by the control unit;

FIG. 5 is a diagram illustrating a detailed configuration of a relay circuit; and

FIG. 6 is a timing diagram for specifically explaining the transition of the application voltage to the coil.

### DETAILED DESCRIPTION OF EMBODIMENTS

Hereinafter, an embodiment of the present disclosure will be described in detail with reference to the drawings. The same or corresponding parts in the drawings are denoted by the same reference numerals, and the description thereof will not be repeated. Each of the embodiments and the modification examples thereof may be combined with each other as appropriate.

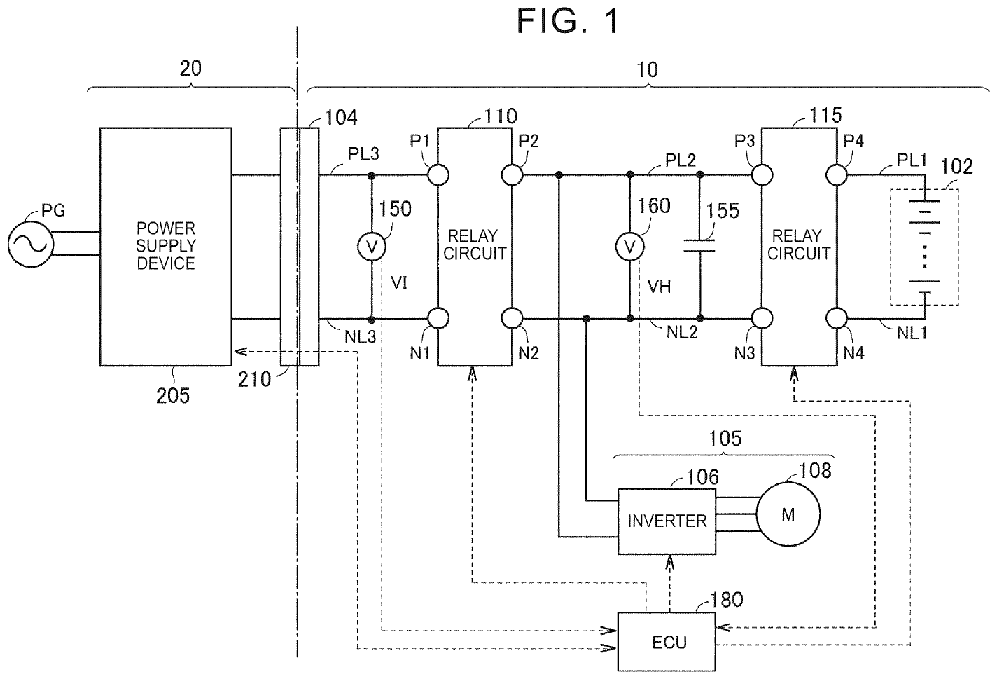

FIG. 1 is a diagram schematically illustrating a configuration of a vehicle in which a relay circuit according to an embodiment is mounted. Referring to FIG. 1, a vehicle 10 is a battery electric vehicle (BEV: Battery Electric Vehicle). The vehicle 10 is configured to be capable of performing power transmission between a power facility 20 (described later) provided outside the vehicle 10 and the vehicle 10. The vehicle 10 may be replaced by other types of electrified vehicle, such as a plug-in hybrid electric vehicle (PHEV).

The vehicle 10 includes a battery 102, a power line PL1 to PL3, NL1 to NL3, an inlet 104, a drive device 105, a relay circuit 110, 115, a voltage sensor 150, 160, a capacitor 155, and an Electronic Control Unit (ECU) 180.

The battery 102 is a secondary battery such as a lithium-ion battery, and is an example of a “power storage device” of the present disclosure. The battery 102 stores electric power for traveling by the vehicle 10.

The power line PL1 is a high-potential-side power line connected to the positive electrode of the battery 102. The power line NL1 is a low-potential-side power line connected to the negative electrode of the battery 102.

The inlet 104 is configured to be connectable to the power facility 20. The power facility 20 includes a power supply device 205 and a connector 210. The power supply device 205 supplies power to the vehicle 10 using the power of the power grid PG. The connector 210 is connected (inserted) to the inlet 104.

The drive device 105 includes an inverter 106 and a motor 108. The inverter 106 is connected to the power line PL2, NL2, and converts DC power supplied from the battery 102 through the relay circuit 115 (described later) into AC power. The motor 108 receives the AC power and generates a driving force for driving the vehicle 10. Each of the power lines PL2, NL2 is a high-potential-side power line and a low-potential-side power line connected to the drive device 105.

The relay circuit 110 is connected to a power line pair (power line PL3, NL3) connected to the inlet 104. The relay circuit 110 includes a terminal P1, P2, N1, N2. Each of the terminals P1, N1 is connected to the power line PL3, NL3. Each of the terminals P2, N2 is connected to the power line PL2, NL2.

The relay circuit 115 is provided between the battery 102 and the drive device 105. The relay circuit 115 includes a terminal P3, P4, N3, N4. Each of the terminals P3, N3 is connected to the power line PL2, NL2. Each of the terminals P4, N4 is connected to the power line PL1, NL1.

Each of the relay circuits 110, 115 includes a plurality of contact relays (described below). The relay circuit 110 is electrically connected at the time of power transmission between the vehicle 10 and the power facility 20. The relay circuit 115 is turned on when the vehicle 10 is driven, and is also turned on when power is transmitted. The power transmission may be either an external charge for charging the battery 102 using the power supplied from the power facility 20 or an external discharge for discharging the discharge power of the battery 102 to the outside of the vehicle 10. In this embodiment, since the power supply is DC power, the external charge is also referred to as “DC charge”. In the following explanation, DC charge is used as an exemplary power transmission.

The voltage sensor 150 detects a voltage VI between the power lines PL3, NL3. The capacitor 155 is connected between a pair of power lines formed of the power line PL2, NL2. The capacitor 155 is precharged with the power of the battery 102 to suppress inrush current at the start of DC charge prior to the start of DC charge. The voltage sensor 160 detects a voltage VH across the capacitor 155. The voltage VH corresponds to the voltage between the power lines PL2, NL2.

ECU 180 includes a processor and memories (none of which are shown). The processor is, for example, a central processing unit (CPU), and executes various arithmetic processes. The memories include a read only memory (ROM) and a random access memory (RAM). ROM stores a program to be executed by the processor.

ECU 180 controls various devices of the vehicle 10 in accordance with a detected value of various physical quantities such as a voltage VI, VH. The device includes a drive device 105 and a relay circuit 110, 115.

With the connector 210 connected to the inlet 104, ECU 180 establishes a communication connection with the power facility 20 by, for example, controller area network (CAN) communication to transmit and receive various signals. In one embodiment, ECU 180 starts DC charging or stops DC charging. ECU 180 notifies the control unit 126, 136 (described later) of the fact when DC charge is started or stopped. ECU 180 exchanges various kinds of information (advance information) with the power facility 20 prior to starting DC charge. ECU 180 executes a predetermined isolation diagnostic process after the pre-information exchange is completed.

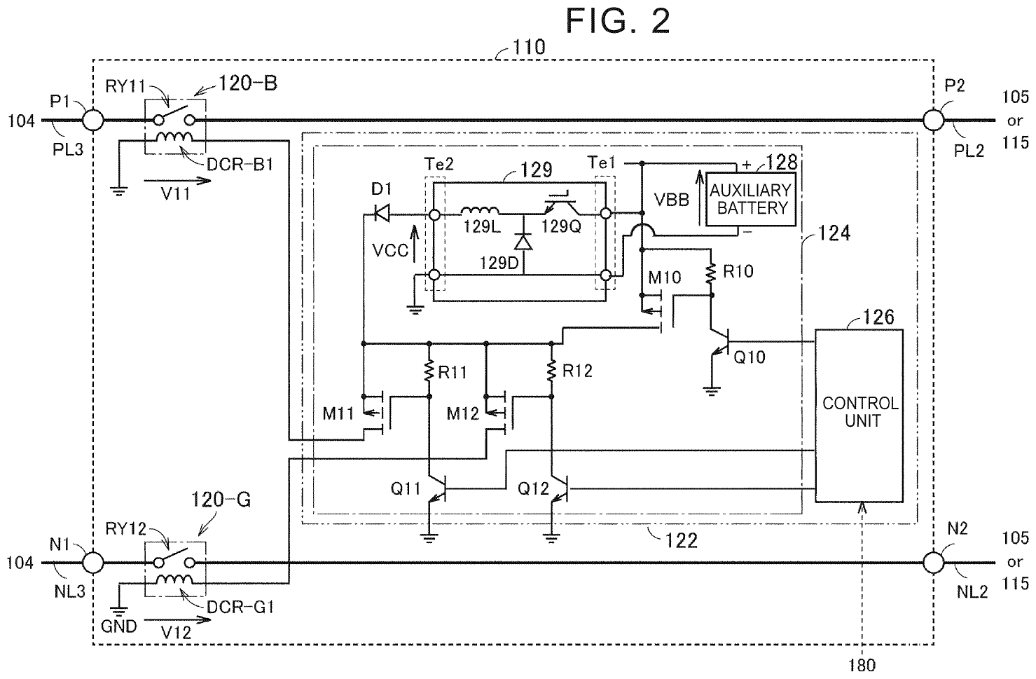

FIG. 2 is a diagram illustrating a detailed configuration of the relay circuit 110. Referring to FIG. 2, the relay circuit 110 includes a contact relay 120-B, 120-G and a voltage generating circuit 122.

Each of the contact relays 120-B, 120-G is a DC charge relay connected to the power line PL3, NL3. The contact relay 120-B includes an electrical contact RY11 and a coil DCR-B1. The electrical contact RY11 is connected between the power lines PL2, PL3 and is driven by the coil DCR-B1 using the electric power of the auxiliary battery 128 (described later). For example, when the application voltage V11 applied to the coil DCR-B1 exceeds the operating voltage of the contact relay 120-B, the electrical contact RY11 is closed. When the application voltage V11 falls below the return voltage of the contact relay 120-B, the electrical contact RY11 is opened. The return voltage is higher than the zero voltage (0 V) and lower than the operating voltage.

The contact relay 120-G includes an electrical contact RY12 and a coil DCR-G1. The electrical contact RY12 is connected between the power lines NL2, NL3 and is driven by the coil DCR-G1 using the electric power of the auxiliary battery 128. For example, when the application voltage V12 applied to the coil DCR-G1 exceeds the operating voltage of the contact relay 120-G, the electrical contact RY12 is closed. When the application voltage V12 falls below the return voltage of the contact relay 120-G, the electrical contact RY12 is opened. The operating voltage and the return voltage of the contact relay 120-G shall be equal to the operating voltage and the return voltage of the contact relay 120-B, respectively.

The voltage generating circuit 122 includes a voltage generation unit 124 and a control unit 126. The voltage generation unit 124 is connected to each of the coil DCR-B1, DCR-G1 and generates an application voltage V11, V12. The voltage generation unit 124 includes an auxiliary battery 128, a step-down converter 129, a diode D1, resistors R10 to R12, and switching elements Q10 to Q12, M10 to M12.

The auxiliary battery 128 functions as a power supply node of the low voltage system such as the voltage generating circuit 122 and generates a power supply voltage VBB. The power supply voltage VBB is higher than the operating voltage of the contact relay 120-B, 120-G.

The step-down converter 129 is a DC/DC converter that converts the power supply voltage VBB into a step-down voltage VCC and outputs it. The step-down voltage VCC is lower than the operating voltage of the contact relay 120-B, 120-G and higher than the return voltage of these contact relays.

The step-down converter 129 includes an input terminal Te1, an output terminal Te2, a switching element 129Q, a diode 129D, and an inductor 129L. The input terminal Te1 is connected to the auxiliary battery 128. The output terminal Te2 is connected to the anode of the diode D1. In the diode D1, current flows only when the anode-side potential (step-down voltage VCC) is higher than the cathode-side potential. The voltage-drop of the diode D1 shall be negligibly small. One main electrode of the switching element 129Q is connected to the positive electrode of the auxiliary battery 128 through the input terminal Te1. The other main electrode of the switching element 129Q is connected to the inductor 129L and the cathode of the diode 129D. The switching element 129Q is driven (turned on and off) by the control unit 126.

Each of the switching elements Q10 to Q12 is a bipolar transistor. Each of the switching elements M10 to M12 is a metal-oxide-semiconductor field-effect transistor (MOSFET).

The control unit 126 controls the on/off status of Q12 from the switching element Q10 in accordance with a command from ECU 180. When the control unit 126 turns on the switching element Q10, the power supply voltage VBB is applied to the resistor R10. The switching element M10 then conducts. When the control unit 126 turns on the switching element Q11, the power supply voltage VBB is applied to the resistor R11. Here, the switching element M11 conducts, and the coil DCR-B1 is electrically connected to the auxiliary battery 128. As a result, the application voltage V11 rises to a power supply voltage VBB higher than the aforementioned operating voltage. Consequently, the electrical contact RY11 is closed. Thereafter, when the control unit 126 turns off both of the switching elements Q10, Q11, the coil DCR-B1 is electrically disconnected from the auxiliary battery 128. As a result, the application voltage V11 drops below the return voltage to zero voltage, and the electrical contact RY11 is opened.

Similarly, when the control unit 126 turns on the switching element Q12 while the switching element M10 is conductive, the power supply voltage VBB is applied to the resistor R12. Here, the switching element M12 conducts, and the coil DCR-G1 is electrically connected to the auxiliary battery 128. As a result, the application voltage V12 rises to the power supply voltage VBB. Consequently, the electrical contact RY12 is closed. Thereafter, when the control unit 126 turns off both of the switching elements Q10, Q12, the application voltage V12 drops to zero voltage, and the electrical contact RY12 is opened.

It is essential to effectively reduce the power dissipation of the auxiliary battery 128 when the electrical contact RY11, RY12 is driven. The lower the application voltage V11, V12, the lower the power dissipation in the coil DCR-B1, DCR-G1. On the other hand, if the application voltage V11, V12 is too low, the electrical contact RY11, RY12 cannot be controlled to be closed. Hereinafter, a configuration of the relay circuit 110 for dealing with such a problem will be described.

When the electrical contact RY11 is driven, the control unit 126 of the relay circuit 110 controls the voltage generation unit 124 to close the electrical contact RY11 by generating an application voltage V11 so that the application voltage V11 exceeds the operating voltage. Thereafter, the control unit 126 controls the voltage generation unit 124 to generate the application voltage V11 such that the application voltage V11 is lowered to an intermediate voltage (in this embodiment, the step-down voltage VCC) within a voltage range that is lower than the aforementioned operating voltage and higher than the return voltage. Similarly, when the electrical contact RY12 is driven, the control unit 126 controls the voltage generation unit 124 to close the electrical contact RY12 by generating the application voltage V12 so that the application voltage V12 exceeds the operating voltage. Thereafter, the control unit 126 controls the voltage generation unit 124 to generate the application voltage V12 such that the application voltage V12 is lowered and held in the step-down voltage VCC.

With such a configuration, the application voltage V11, V12 is lowered to the step-down voltage VCC and held after the electrical contact RY11, RY12 is closed. Since the step-down voltage VCC is higher than the return voltage, the closed state of these electrical contacts is maintained. When the application voltage V11, V12 is the step-down voltage VCC, the power consumption in the coil DCR-B1 and DCR-G1 is lower than when the application voltage V11, V12 is the power supply voltage VBB. Therefore, according to the above-described configuration, it is possible to reduce power dissipation in the coil DCR-B1, DCR-G1 while maintaining the closed condition of the electrical contact RY11, RY12. As a consequence, the power dissipation of the auxiliary battery 128 when driving these electrical contacts during DC charge can be effectively reduced (power efficiency can be improved).

Hereinafter, a method for increasing the application voltage V11, V12 to the power supply voltage VBB and then decreasing it to the step-down voltage VCC will be described in more detail. For example, with respect to the application voltage V11, the control unit 126 electrically connects the auxiliary battery 128 to the coil DCR-B1 by turning on the switching element Q11 (making the switching element M10, M11 conductive) after the switching element Q10 is turned on. As a result, the application voltage V11 rises to the power supply voltage VBB, and the electrical contact RY11 is closed. Thereafter, the control unit 126 turns off the switching element Q10 to electrically connect the output terminal Te2 of the step-down converter 129 to the coil DCR-B1 instead of the auxiliary battery 128 through the diode D1. As a result, the application voltage V11 decreases to the step-down voltage VCC.

Similarly, with respect to the application voltage V12, the control unit 126 electrically connects the auxiliary battery 128 to the coil DCR-G1 by turning on the switching element Q12 (making the switching element M10, M12 conductive) after the switching element Q10 is turned on. As a result, the application voltage V12 rises to the power supply voltage VBB, and the electrical contact RY12 is closed. Thereafter, the control unit 126 turns off the switching element Q10 to electrically connect the output terminal Te2 of the step-down converter 129 to the coil DCR-G1 instead of the auxiliary battery 128 through the diode D1. As a result, the application voltage V12 decreases to the step-down voltage VCC.

When the auxiliary battery 128 is electrically connected to the coil DCR-B, DCR-G, each of the application voltages V11, V12 is the power supply voltage VBB. When the connection destination of each of the coil DCR-B, DCR-G is switched from the auxiliary battery 128 to the output terminal Te2 of the step-down converter 129, each of the application voltages V11, V12 decreases from the power supply voltage VBB to the step-down voltage VCC. Therefore, by switching the connection destinations of the coils as described above, the application voltage V11, V12 can be easily held within a voltage range that is less than the operating voltage and equal to or higher than the return voltage.

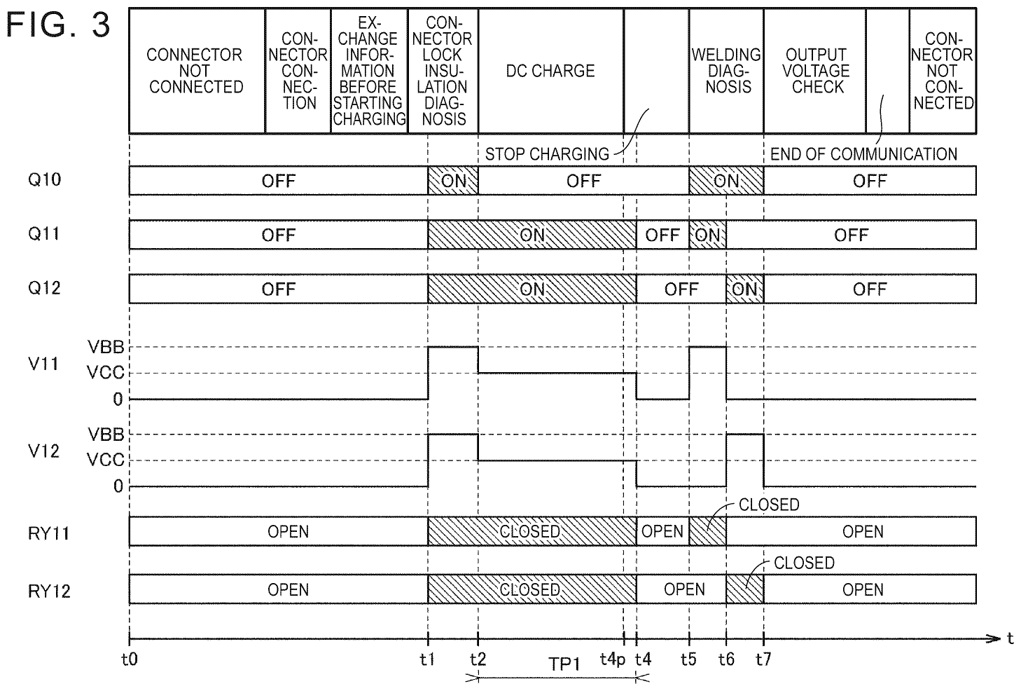

FIG. 3 is a timing diagram for specifically explaining the transition of the application voltage V11, V12 in the embodiment. This diagram shows, in order from the top, the on/off state of Q12 from the switching element Q10, the application voltage V11, V12, and the open/close state of the electrical contact RY11, RY12.

Referring to FIG. 3, during a period from the time t0 to the time t1, the connector 210 is connected to the inlet 104, and the above-described prior information is exchanged between ECU 180 and the power facility 20. Then, a user operation for locking the connector 210 is performed, and the insulation diagnosis process is started. During the period from the time t0 to the time t1, the switching elements Q10 to Q12 are in the off-state, and the application voltage V11, V12 is the zero voltage. Thus, the electrical contact RY11, RY12 is open.

In the time t1, the control unit 126 turns on Q12 from the switching element Q10. As a result, each of the coil DCR-B1, DCR-G1 is electrically connected to the auxiliary battery 128, and the application voltage V11, V12 increases from the zero voltage to the power supply voltage VBB. Consequently, the electrical contact RY11, RY12 is closed.

In the time t2, DC charge starts, and the control unit 126 turns off the switching element Q10. As a result, the connection destination of the respective coils is switched from the auxiliary battery 128 to the output terminal Te2 of the step-down converter 129, and the application voltage V11, V12 decreases from the power supply voltage VBB to the step-down voltage VCC. During the period (period TP1) from the time t2 to the time t4, each of these application voltages is held in the step-down voltage VCC, so that the electrical contact RY11, RY12 remains closed. At a time t4p that is a predetermined time prior to the time t4, DC charge is stopped.

In the time t4, the control unit 126 turns off the switching element Q11, Q12. As a result, the switching element M11, M12 no longer conducts. As a consequence, the coils are electrically disconnected from the step-down converter 129, and the application voltage V11, V12 drops below the return voltage to zero voltage. Thus, the electrical contact RY11, RY12 is opened.

During the period from the time t5 to the time t7, ECU 180 executes a welding diagnostic process for diagnosing the presence or absence of welding of the electrical contact RY11, RY12 in accordance with the voltage VH.

After the time t7, ECU 180 checks VI and terminates the communication with the power facility 20. After a user operation to unlock the connector 210, the connector 210 is withdrawn from the inlet 104.

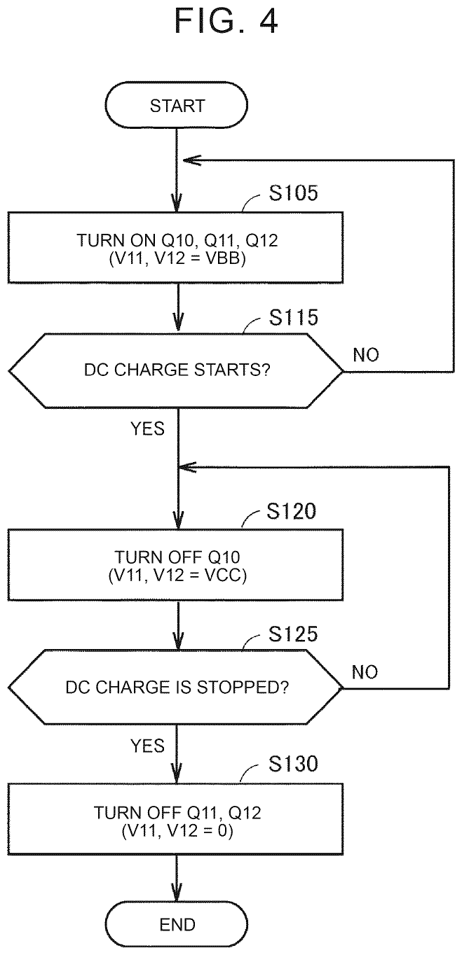

FIG. 4 is a flowchart illustrating a process executed by the control unit 126. This flow chart is started after the pre-information is exchanged (at time t1 in FIG. 3).

Referring to FIG. 4, the control unit 126 turns on the switching element Q11, Q12 (S105). As a result, the application voltage V11, V12 exceeds the operating voltage and rises to the power supply voltage VBB, and the electrical contact RY11, RY12 is closed.

The control unit 126 determines whether or not DC charge has started in accordance with a notification from ECU 180 (S115). When DC charge has not yet started (NO in S115), the process returns to S105, and the application voltage V11, V12 is held at the power supply voltage VBB. When DC charge starts (YES in S115), the process proceeds to S120.

When DC charge starts, the control unit 126 turns off the switching element Q10 while maintaining the on-state of the switching element Q11, Q12 (S120). As a result, the application voltage V11, V12 decreases to the step-down voltage VCC, but the electrical contact RY11, RY12 is maintained closed.

The control unit 126 determines whether or not DC charge is stopped in accordance with a notification from ECU 180 (S125). When DC charge is not yet stopped (NO in S125), the process returns to S120, and the application voltage V11, V12 is held in the step-down voltage VCC. When DC charge is stopped (YES in S125), the control unit 126 waits for a predetermined period, and then turns off the switching element Q11, Q12 at the time t4 (S130). As a result, the application voltage V11, V12 drops to zero voltage, and the electrical contact RY11, RY12 is opened. Thereafter, the process ends.

The vehicle 10 may perform DC charge by establishing an electric connection between the vehicle 10 and the power facility 20. In order to establish the electrical connection, the electrical contact RY11, RY12 of the relay circuit 110 must be closed. According to the embodiment, it is possible to effectively reduce the power dissipation of the auxiliary battery 128 when the electrical contacts are controlled to be in the closed state (for example, during the period TP1). Further, it is possible to avoid a situation in which the electric power of the auxiliary battery 128 is exhausted due to the electric power consumed in the low-voltage system of the vehicle 10 after DC charge is completed.

### Modification

In this modification, control for reducing power consumption during driving of the electrical contacts of the relay circuit 115 (FIG. 1) will be described. As described below, the above-described voltage-control for the contact relay 120-B, 120-G is also applicable to the contact relays of the relay circuit 115.

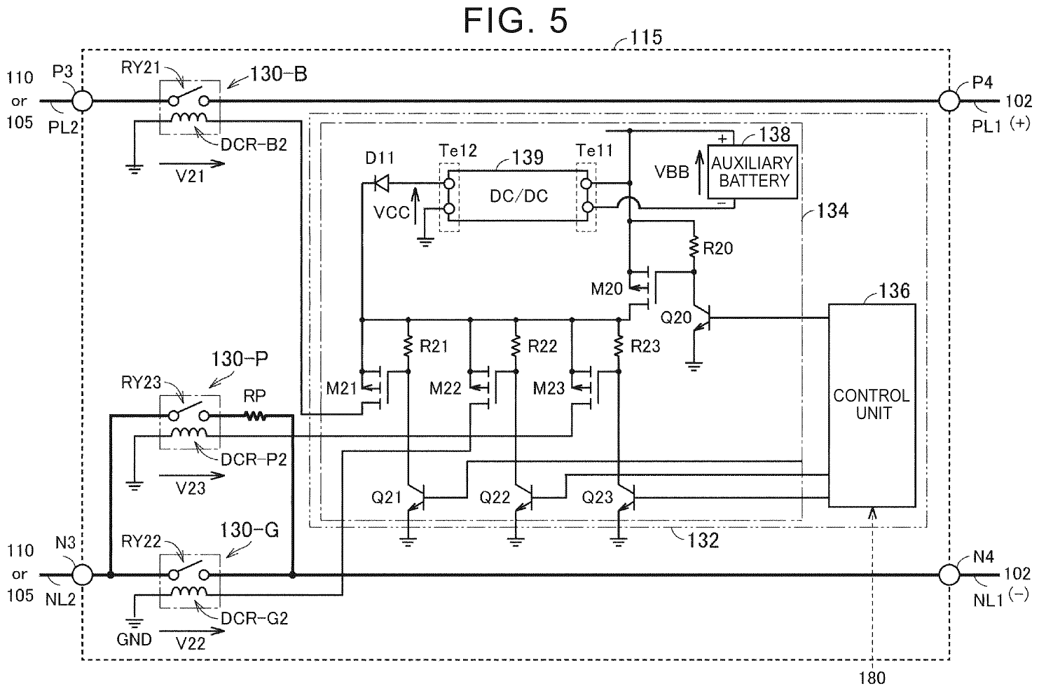

FIG. 5 is a diagram illustrating a detailed configuration of the relay circuit 115. Referring to FIG. 5, the relay circuit 115 differs from the relay circuit 110 (FIG. 2) in that it includes a contact relay 130-B, 130-G and a voltage generating circuit 132 in place of the contact relay 120-B, 120-G and the voltage generating circuit 122. The relay circuit 115 further differs from the relay circuit 110 in that it includes a contact relay 130-P and a resistance element RP.

Each of the contact relay 130-B, 130-G, 130-P is a system main relay provided on an electrical path between the batteries 102 and the drive device 105. The contact relay 130-B includes an electrical contact RY21 and a coil DCR-B2. The contact relay 130-G includes an electrical contact RY22 and a coil DCR-G2. The contact relay 130-P includes an electrical contact RY23 and a coil DCR-P2. The voltage applied to the coil DCR-B2, DCR-G2, DCR-P2 is also referred to as an application voltage V21, V22, V23.

The electrical contact RY21 is connected between the power lines PL1, PL2. The electrical contact RY22 is connected between the power lines NL1, NL2. The electrical contact RY23 is provided in parallel with the electrical contact RY22 and is connected to the power line NL1 through the resistance element RP. The resistance element RP is connected to the electrical contact RY23 and is provided as a discharging resistor for precharging the capacitor 155 (FIG. 1).

The electrical contact RY21 is driven by the coil DCR-B2 in accordance with the application voltage V21. The electrical contact RY22 is driven by the coil DCR-G2 in accordance with the application voltage V22. The electrical contact RY23 is driven by the coil DCR-P2 in accordance with the application voltage V23.

For example, when the application voltage V21 exceeds the operating voltage of the contact relay 130-B, the electrical contact RY21 is closed. When the application voltage V21 falls below the return voltage of the contact relay 130-B, the electrical contact RY21 is opened. Similarly, when the application voltage V22, V23 exceeds the operating voltage of the contact relay 130-G and the operating voltage of the contact relay 130-P, respectively, the electrical contact RY22, RY23 is closed. When the application voltage V22, V23 falls below the return voltage of the contact relay 130-G and the return voltage of the contact relay 130-P, respectively, the electrical contact RY22, RY23 is opened.

It is assumed that the operating voltages of the contact relay 130-B, 130-G, 130-P are equal to each other and the same as the operating voltages of the contact relay 120-B, 120-G (FIG. 2). Similarly, it is assumed that the return voltages of the contact relays 130-B, 130-G, 130-P are equal to each other and the same as the return voltages of the contact relays 120-B, 120-G.

The voltage generating circuit 132 includes a voltage generation unit 134 and a control unit 136. The voltage generation unit 134 is connected to each of the coil DCR-B2, DCR-G2, DCR-P2 and is configured to generate an application voltage V21, V22, V23. The voltage generation unit 124 includes an auxiliary battery 138, a step-down converter 139, a diode D11, resistors R20 to R23, and switching elements Q20 to Q23, M20 to M23.

The auxiliary battery 138, the step-down converter 139, and the diode D11 are the same as the auxiliary battery 128, the step-down converter 129, and the diode D1 (both shown in FIG. 2), respectively. Each of the switching elements Q20 to Q23 is a bipolar transistor. Each of the switching elements M20 to M23 is a MOSFET.

The control unit 136 controls the on/off status of Q23 from the switching element Q20 in accordance with a command from ECU 180. When the control unit 136 turns on the switching element Q10, the power supply voltage VBB is applied to the resistor R20. The switching element M20 then conducts. When the control unit 136 turns on the switching element Q21, the power supply voltage VBB is applied to the resistor R21. Here, the switching element M21 conducts, and the coil DCR-B2 is electrically connected to the auxiliary battery 138. As a result, the application voltage V21 rises to a power supply voltage VBB higher than the operating voltage. Consequently, the electrical contact RY21 is closed. Thereafter, when the control unit 136 turns off both of the switching elements Q20, Q21, the coil DCR-B2 is electrically disconnected from the auxiliary battery 138. As a result, the application voltage V21 drops below the return voltage to zero voltage, and the electrical contact RY21 is opened.

Similarly, when the control unit 136 turns on the switching element Q22 while the switching element M20 is conductive, the power supply voltage VBB is applied to the resistor R22. Here, the switching element M22 conducts, and the coil DCR-G2 is electrically connected to the auxiliary battery 138. As a result, the application voltage V22 rises to the power supply voltage VBB. Consequently, the electrical contact RY22 is closed. Thereafter, when the control unit 136 turns off both of the switching elements Q20, Q22, the application voltage V22 drops to zero voltage, and the electrical contact RY22 is opened.

Similarly, when the control unit 136 turns on the switching element Q23 while the switching element M20 is conductive, the power supply voltage VBB is applied to the resistor R23. Here, the switching element M23 conducts, and the coil DCR-P2 is electrically connected to the auxiliary battery 138. As a result, the application voltage V23 rises to the power supply voltage VBB. Consequently, the electrical contact RY23 is closed. Thereafter, when the control unit 136 turns off both of the switching elements Q20, Q23, the application voltage V23 drops to zero voltage, and the electrical contact RY23 is opened. When the electrical contact RY21, RY23 is closed prior to starting DC charge, the capacitor 155 is precharged. After the precharge of the capacitor 155 is completed, DC charge is started when the electrical contact RY22 is closed and the electrical contact RY23 is opened.

The control unit 136 performs, for each of the electrical contact RY21, RY22, voltage-control similar to that of the control unit 126 in the embodiment. Hereinafter, this point will be described in detail.

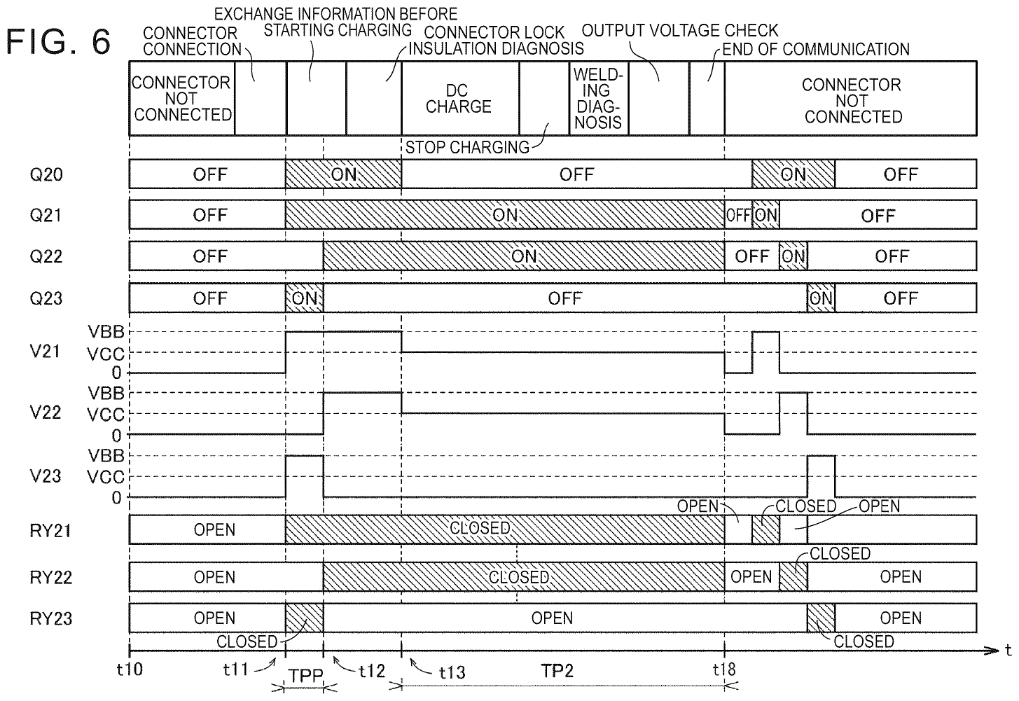

FIG. 6 is a timing diagram for specifically explaining the transition of the application voltage V21, V22, V23 in this modification. This diagram shows, in order from the top, the on/off state of Q23 from the switching element Q20, V23 from the application voltage V21, and the open/close state of RY23 from the electrical contact RY21.

Referring to FIG. 6, in the time t11 after the time t10, the above-described exchange of the prior information is started, and the control unit 136 turns on the switching element Q20, Q21, Q23. As a result, the switching element M20, M21, M23 becomes conductive. Consequently, the coil DCR-B2, DCR-P2 is electrically connected to the auxiliary battery 138, and the application voltage V21, V23 rises from zero voltage to the power supply voltage VBB. Consequently, the electrical contact RY21, RY23 is closed. During period TPP (time t11 to time t12), these contacts remain closed and capacitor 155 is precharged.

In the time t12, the voltage VH reaches a predetermined threshold voltage, and the precharge of the capacitor 155 is completed. The control unit 136 turns on the switching element Q22 and turns off the switching element Q23. As a result, the switching element M22 is conducted, while the switching element M23 is no longer conducted. Consequently, the coil DCR-G2 is connected to the auxiliary battery 138, and the coil DCR-P2 is electrically disconnected from the auxiliary battery 138. Consequently, the application voltage V22 increases from zero voltage to the power supply voltage VBB, and the application voltage V23 decreases from the power supply voltage VBB to zero voltage. Thus, the electrical contact RY22 is closed and the electrical contact RY23 is opened.

In the time t13, when DC charge starts, the control unit 136 controls the voltage generation unit 134 so as to generate the application voltage V21, V22 such that each of the application voltages V21, V22 is lowered and held in the step-down voltage VCC. Specifically, the control unit 136 turns off the switching element Q20. As a result, the connection destination of each coil DCR-B2, DCR-G2 is switched from the auxiliary battery 138 to the output terminal Te12 of the step-down converter 139. Consequently, the application voltage V11, V12 decreases from the power supply voltage VBB to the step-down voltage VCC. During the period TP2 (time t13 to time t18), each of these application voltages is held in the step-down voltage VCC, so that the electrical contact RY21, RY22 remains closed. Consequently, the power consumption in the coil DCR-B2, DCR-G2 (the power consumption of the auxiliary battery 138) can be reduced while these electrical contacts are maintained in the closed state during the period TP2.

In the time t18, the control unit 136 turns off the switching element Q21, Q22. As a result, each of the coil DCR-B2, DCR-G2 is electrically disconnected from the step-down converter 139, and the application voltage V21, V22 decreases from the step-down voltage VCC to zero voltage. Consequently, the electrical contact RY21, RY22 is opened.

As described below, the control unit 136 may control the voltage generation unit 134 so that each of the application voltages V21, V23 is kept lowered from the power supply voltage VBB to the step-down voltage VCC during the period TPP (application voltage control during the precharge period). Specifically, the control unit 136 may turn off the switching element Q20 while the switching element M10 is conductive during the period TPP. As a result, the connection destination of each of the coil DCR-B2, DCR-P2 is switched from the auxiliary battery 138 to the output terminal Te12 of the step-down converter 139, and each of the application voltage V21, V23 is lowered to the step-down voltage VCC.

Thereafter, the control unit 136 turns on the switching element Q20 again immediately before the time t12 (before the reference time), thereby causing the switching element M10 to conduct again. As a result, the destination of each of the coil DCR-B2, DCR-P2 is switched from the output terminal Te12 to the auxiliary battery 138 again, and each of the application voltages V21, V23 rises again from the step-down voltage VCC to the power supply voltage VBB. After the arrival of the time t12, the control unit 136 executes the control of Q23 from the switching elements Q20 after the time t12 described above.

With this configuration, power dissipation in the coil DCR-B2, DCR-P2 can be reduced while the electrical contact RY21, RY23 is kept closed during the period TPP. The application voltage control described above is more effective as the length of the period TPP is longer (or as the period during which the application voltage V21, V23 is held in the step-down voltage VCC is longer). Therefore, the control unit 136 may execute the above-described application voltage control when the length of the period TPP is longer than the predetermined threshold time.

As described above, according to this modification, power dissipation of the auxiliary battery 138 when the electrical contact RY21, RY22, RY23 of the relay circuit 115 is driven for DC charge or the like can be reduced.

It should be considered that the embodiments disclosed above are for illustrative purposes only and are not limitative of the disclosure in any aspect. It is intended that the scope of the disclosure be defined by the appended claims rather than the foregoing description, and that all changes within the meaning and range of equivalency of the claims be embraced therein.

What is claimed is:

1. A relay circuit comprising:
a contact relay including an electrical contact and a coil configured to drive the electrical contact; and
a voltage generating circuit connected to the coil and configured to generate an application voltage for the coil, wherein:
the electrical contact is closed when the application voltage exceeds a first voltage;
the electrical contact is opened when the application voltage is below a second voltage lower than the first voltage; and
the voltage generating circuit is configured to generate the application voltage exceeding the first voltage to close the electrical contact, and then generate the application voltage reduced to and kept at a third voltage lower than the first voltage and higher than the second voltage.

2. The relay circuit according to claim 1, wherein:
the voltage generating circuit includes
a power supply node configured to generate a power supply voltage higher than the first voltage, and
a converter including an input terminal connected to the power supply node and configured to convert the power supply voltage into the third voltage and output the third voltage; and
the voltage generating circuit is configured to connect the power supply node to the coil, and then connect an output terminal of the converter to the coil instead of the power supply node.

3. A vehicle comprising:
the relay circuit according to claim 1; and
an inlet connectable to power equipment provided outside the vehicle, wherein the contact relay is connected to a power line connected to the inlet.

4. A vehicle comprising:
the relay circuit according to claim 1;
a power storage device configured to store electric power for traveling of the vehicle; and
a drive device configured to generate a traveling drive force for the vehicle, wherein the contact relay is provided on an electric path between the power storage device and the drive device.

5. The vehicle according to claim 4, wherein:
the vehicle is configured to perform power transfer between the vehicle and power equipment outside the vehicle;
the vehicle further includes a capacitor connected between a first high-potential-side power line and a first low-potential-side power line each connected to the drive device;
the contact relay includes a first contact relay, a second contact relay, and a third contact relay;
the first contact relay includes a first contact as the electrical contact connected between a second high-potential-side power line connected to a positive electrode of the power storage device and the first high-potential-side power line, and a first coil configured to drive the first contact;
the second contact relay includes a second contact as the electrical contact connected between a second low-potential-side power line connected to a negative electrode of the power storage device and the first low-potential-side power line, and a second coil configured to drive the second contact;
the third contact relay includes a third contact as the electrical contact connected to the second low-potential-side power line through a resistance element for precharge of the capacitor, and a third coil configured to drive the third contact;
the voltage generating circuit is configured to generate a first application voltage as the application voltage for the first coil, a second application voltage as the application voltage for the second coil, and a third application voltage as the application voltage for the third coil;
the capacitor is precharged when the first contact and the third contact are closed before start of the power transfer;
the power transfer is started when the second contact is closed and the third contact is opened after the precharge of the capacitor is completed; and
the voltage generating circuit is configured to
generate the first application voltage and the third application voltage each reduced to and kept at the third voltage during the precharge of the capacitor, and
generate the first application voltage and the second application voltage each reduced to and kept at the third voltage when the power transfer is started.
